(19) United States
(12) Patent Application Publication
(10) Pub. No.: US 2010/0061217 A1
(43) Pub. Date: Mar. 11, 2010

(54) OPTICAL HEAD UNIT AND OPTICAL INFORMATION RECORDING/REPRODUCING APPARATUS

(75) Inventor: Ryuichi Katayama, Minato-ku (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION, Minato-ku, Tokyo (JP)

(21) Appl. No.: 12/517,294

(22) PCT Filed: Nov. 30, 2007
(86) PCT No.: PCT/JP2007/073142

§ 371 Date: Jun. 2, 2009

(30) Foreign Application Priority Data
Dec. 5, 2006 (JP) 2006-328490

(51) Int. Cl. G11B 7/135; G11B 7/00; G11B 20/18

(52) U.S. Cl. 369/112.03; 369/112.23; 369/53.15; G9B/7; G9B/20

(57) ABSTRACT

Semiconductor lasers emit lights having wavelengths of about 400 nm, 650 nm, and 780 nm, respectively. A transmittance adjustment element is provided in an optical path of the light reflected from a disk. The transmittance adjustment element includes a first optical thin film that changes transmittance of a 650-nm-wavelength light relatively to transmittance of 400-nm- and 780-nm-wavelength lights, and a second optical thin film that changes transmittance of a 780-nm-wavelength light relatively to transmittance of 400-nm- and 650-nm-wavelength lights. The transmittance adjustment element has the function of maintaining constant the intensity of light incident onto a photodetector irrespective of the type of medium.

### TECHNICAL FIELD

The present invention relates to an optical head unit and an optical recording/reproducing apparatus and, more particularly, to an optical head unit for performing recording and reproducing on an optical recording media of three or more standards for which different light wavelengths are used, and an information recording/reproducing apparatus that includes such an optical head unit.

### BACKGROUND ART

Optical recording media onto which a laser beam is irradiated and from which a reflected light is received for performing recording an reproducing are widely used. The optical recording media include a plurality of types of optical recording medium for which different light wavelengths are used and which have different recording densities, and thus it is desired that the optical information recording/reproducing apparatus have a compatible function of performing the recording and reproducing on a plurality of types of the optical recording medium. The term optical recording/reproducing apparatus used hereinafter includes both a recording/reproducing apparatus that performs both the recording and reproducing and a dedicated reproducing apparatus that performs only the reproducing, for the sake of convenience.

The recording density of the optical information recording/reproducing apparatus is inversely proportional to the square of diameter of a focused spot that the optical head unit forms on the optical recording medium. That is, a smaller diameter of the focused spot raises the recording density. The diameter of the focused spot is proportional to the wavelength of a light source in the optical head unit, and inversely proportional to the numerical aperture of the objective lens. That is, a shorter wavelength of the light source as well as a higher numerical aperture of the objective lens reduces the diameter of the focused spot. With respect to an optical recording medium of CD (compact disk) standard having a capacity of 650 MB, the wavelength of the light source is 780 nm and the numerical aperture of the objective lens is 0.45. With respect to a DVD (digital versatile disk) standard having a capacity of 4.7 GB, the wavelength of the light source is about 650 nm, and the numerical aperture of the objective lens is 0.6.

Meanwhile, the typical reflectance as well as the typical recording power and reproducing power of the optical recording media differs depending on the types of the optical recording media. Thus, assuming that the backward-path efficiency, which is the ratio of the intensity of light that is incident onto a photodetector to the intensity of light reflected by the optical recording medium, is constant irrespective of the types of optical recording media, the intensity of light that is incident onto the photodetector during the recording and reproducing differs depending on the types of the optical recording media. As a result, the level of the voltage signal output from the photodetector during the recording and reproducing differs depending on the types of the optical recording media. If the level of the voltage signal output from the photodetector is excessively lower, and if the voltage signal is amplified in a subsequent-stage preamplifier, the signal-to-noise ratio of the voltage signal after the amplification is lowered, whereby a correct recording or reproducing cannot be performed with respect to the optical recording medium. In addition, if the level of the voltage signal is excessively higher, and if the voltage signal is amplified in a subsequent-stage preamplifier, the voltage signal after the amplification is saturated, whereby a correct recording or reproducing cannot be performed with respect to the optical recording medium.

In order to obtain a constant level for the level of voltage signal output from the photodetector irrespective of the type of the optical recording medium, it is effective to change the backward-path efficiency in the optical head unit depending on the type of the optical recording medium. By controlling the backward-path efficiency, the intensity of light that is incident onto the photodetector during the recording and reproducing can be made constant irrespective of the type of the optical recording medium, whereby a correct recording or reproducing can be performed with respect to the optical recording medium of each standard.

As the optical head units that can obtain, from the optical recording media of two different standards, a constant intensity of light incident onto the photodetector irrespective of the type of the optical recording medium, there is one described in Patent Publication-1. FIG. 14 shows the configuration of the optical head unit described in Patent Publication-1. The optical head unit 200 is configured as an optical head unit that handles an optical recording medium of DVD standard and an optical recording medium of CD standard.

If the disk 207 is an optical recording medium of CD standard, a semiconductor laser (LD) 201a corresponding to the CD standard is turned ON. A 780-nm-wavelength light emitted from the semiconductor laser 201a is divided by a diffraction grating 202 into three lights including a zero-order diffracted light and ±first-order diffracted lights. These lights pass through a coupling lens 203, partly passes through a beam splitter 204, and is collimated by a collimating lens 205 to be focused by an objective lens 206 onto the disk 207 of CD standard. The reflected light from the disk 207 passes through the objective lens 206 and collimating lens 205 in a backward direction, and is partially reflected by the beam splitter 204. The light reflected by the beam splitter 204 partially passes through another beam splitter 208, and passes through a light-intensity adjustment film 209 and a cylindrical lens 210, to be received by a photodetector 211.

If the disk 207 is an optical recording medium of DVD standard, another semiconductor laser 201b corresponding to the DVD standard is turned ON. A 650-nm-wavelength light emitted from the semiconductor laser 201b is partially reflected by the beam splitter 208, then a part of the reflected light is reflected by the beam splitter 204, and is collimated by the collimating lens 205, to be focused by the objective lens 206 onto the disk 207 of DVD standard. The reflected light from the disk 207 passes through the objective lens 206 and collimating lens 205 in the backward direction, is partially reflected by the beam splitter 204, partially passes through the beam splitter 208, passes through the light-intensity adjustment film 209 and cylindrical lens 210, to be received by the photodetector 211.

The light-intensity adjustment film 209 is provided on a surface of the beam splitter 208 near the cylindrical lens 210. The transmittance of the light-intensity adjustment film 209 is set at 100% with respect to a 780-nm-wavelength light, and 20% with respect to a 650-nm-wavelength light. Setting the transmittance of the light-intensity adjustment film 209 depending on the wavelength of light passing therethrough in this way allows the backward-path efficiency in the optical head unit to be changed depending on the wavelength. That is, the backward-path efficiency can be changed depending on the type of disk 207, whereby the intensity of light that is incident onto the photodetector 211 is made constant irrespective of the type of disk 207.

FIG. 15 shows another example of the optical head unit that is described in Patent Publication-1. The optical head unit 200a shown in FIG. 15 has a configuration wherein the light-intensity adjustment film 209 in the optical head unit 200 shown in FIG. 14 is replaced by a diffraction grating 212. The diffraction grating 212 is formed on a surface of the cylindrical lens 210 opposing the photodetector 211. The ratio of transmittance with respect to a 780-nm- wavelength light to the transmittance with respect to a 650-nm- wavelength light is set at 1:0.2 in the diffraction grating 212. Use of such a diffraction grating 212, as in the case of using the light-intensity adjustment film 209, allows the backward-path efficiency in the optical head unit to be changed depending on the type of disk 207, whereby the intensity of light that is incident onto the photodetector 211 is made constant irrespective of the type of disk 207.

In order to further improve the recording density, some standards that allow further reduction of wavelength of the light source and further increase of the numerical aperture of the objective lens are practically used in recent years. Such standards include HD DVD (high-density digital versatile disk) standard. The HD DVD standard is such that the wavelength of light source is around 400 nm, the numerical aperture of the objective lens is 0.65, and the capacity is 15 GB to 20 GB. An optical disk unit that can perform recording/reproducing on an optical recording medium of HD DVD standard, in addition to CD standard and DVD standard, has been proposed. Patent Publication-2, for example, describes an example of such an optical head unit.

Patent Publication-1: JP-2003-308625A

Patent Publication-2: JP-2005-141892A

In the optical head unit that can perform recording/reproducing on the optical recording medium of three different standards, such as including HD DVD standard, DVD standard and CD standard, it is needed as well to achieve a constant value of the intensity of light that is incident onto the photodetector or the level of voltage signal that is output from the photodetector during the recording/reproducing, irrespective of the types of optical recording media. However, there is no description on the optical head unit having such a function in each of Patent Publication-1 and Patent Publication-2.

In Patent Publication-1, the ratio of the backward-path efficiency is set at a desired value with respect to lights of two different wavelengths by using the light-intensity adjustment film 209 or diffraction grating 212. If extension of this configuration is possible to achieve setting of a desired ratio of the backward-path efficiency for the lights of three different waveforms, the above-described function may be realized. However, use of a light-intensity adjustment film similar to the light-intensity adjustment film 209, or a diffraction grating similar to the diffraction grating 212 cannot achieve the above setting. In addition, the optical head unit described in Patent Publication-2 performs only the recording and reproducing on the media of three different standards, and thus does not have the above-described function.

### SUMMARY OF THE INVENTION

It is an object of the present invention to provide an optical head unit and an optical information recording/reproducing apparatus that are capable of achieving a constant value of the intensity of light that is incident onto a photodetector or the level of voltage signal output from the photodetector, with respect to optical recording media of three different standards during recording and reproducing thereon.

The present invention provides an optical head unit including: first through third light sources that emit first- through third-wavelength lights, respectively, that are different from one another in wavelength; an objective lens that focuses lights emitted from the first through third light sources onto an optical recording medium; a photodetector that receives a reflected light reflected by the optical recording medium; an efficiency adjustment member disposed in an optical path of the reflected light to change a backward-path efficiency, which is a ratio between an intensity of light reflected by the optical recording medium and an intensity of light incident onto the photodetector, depending on a wavelength of the reflected light, wherein the efficiency adjustment member includes a first partial-efficiency adjustment member that changes the backward-path efficiency with respect to the first-wavelength light relatively to the backward-path efficiency with respect to the second- and third-wavelength lights, and a second partial-efficiency adjustment member that changes the backward-path efficiency with respect to the second-wavelength light relatively to the backward-path efficiency with respect to the first- and third-wavelength lights.

The present invention provides an optical information recording/reproducing apparatus including: the optical head unit of the present invention as described above: a first circuitry that selectively drives the first through third light sources to emit one of the first- through third-wavelength lights; a second circuitry that detects mark/space signals formed along an information track, provided on the optical recording medium, based on an output from the photodetector; and a third circuitry that detects a focus error signal representing a positional deviation representing of the focused spot along an optical axis direction and a tracking error signal representing a positional deviation of the focused spot with respect to the information track within a plane perpendicular to the optical axis direction, and drives the objective lens based on the focus error signal and the tracking error signal.

The above and other objects, features and advantages of the present invention will be more apparent from the following description, referring to the accompanying drawings.

### BRIEF DESCRIPTION OF THE DRAWINGS

FIG. 1 is a block diagram showing the configuration of an optical head unit according to a first exemplary embodiment of the present invention.

FIG. 2 is a graph showing a wavelength dependency of the optical transmittance of a polarization beam splitter.

FIG. 3 is a g graph showing a wavelength dependency of the optical transmittance of another polarization beam splitter.

FIG. 4 is a graph showing a wavelength dependency of the optical transmittance of another polarization beam splitter.

FIG. 5 is a top plan view showing the pattern of light receiving parts of the photodetector and arrangement of the optical spots on the photodetector.

FIG. 6 is a graph showing a wavelength dependency of the transmittance of a first optical thin film formed in the transmittance adjustment element.

FIG. 7 is a graph showing a wavelength dependency of the transmittance of a second optical thin film formed in the transmittance adjustment element.

FIG. 8 is a block diagram showing the configuration of an optical head unit according to a second exemplary embodiment of the present invention.

FIG. 9 is a sectional view showing the sectional structure of the transmittance adjustment element.

FIG. 10 is a block diagram showing the configuration of an optical head unit according to a third exemplary embodiment of the present invention.

FIG. 11 is a graph showing a wavelength dependency of the transmittance of a polarization beam splitter.

FIG. 12 is a graph showing a wavelength dependency of the transmittance of another polarization beam splitter.

FIG. 13 is a block diagram showing the configuration of an optical information recording/reproducing apparatus including the optical head unit according to the first exemplary embodiment of the present invention.

FIG. 14 is a block diagram showing the configuration of the optical head unit described in Patent Publication-1.

FIG. 15 is a block diagram showing another configuration example of the optical head unit described in Patent Publication-1.

### BEST MODE OF CARRYING OUT THE INVENTION

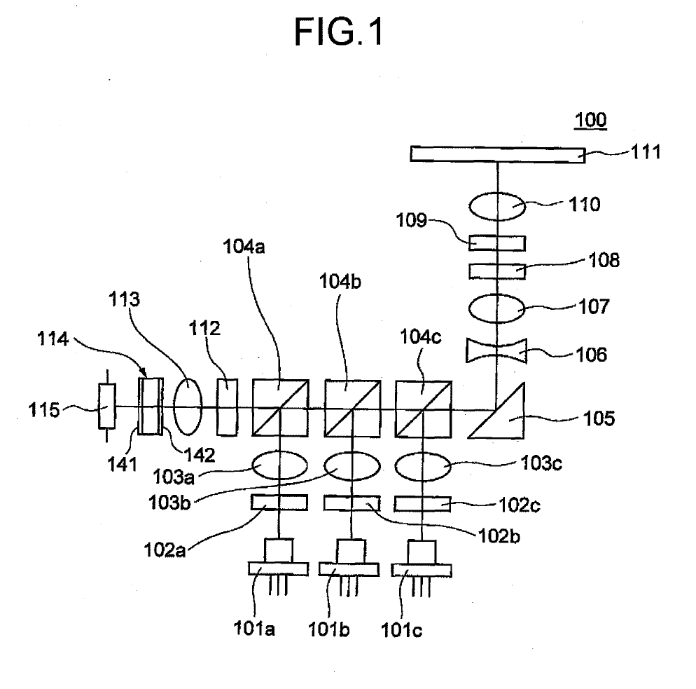

Hereinafter, with reference to the drawings, exemplary embodiments of the present invention will be described in detail. FIG. 1 shows the configuration of an optical head unit according to a first exemplary embodiment of the present invention. The optical head unit 100 includes semiconductor lasers 101a-101c, diffraction optical elements 102a-102c, collimating lenses 103a-103c, polarization beam splitters 104a-104c, a mirror 105, a concave lens 106, a convex lens 107, a ¼-wavelength plate 108, a numerical-aperture control element 109, an objective lens 110, a cylindrical lens 112, another convex lens 113, a transmittance adjustment element 114, and a photodetector 115.

The optical head unit is configured as an optical head unit that can perform recording and reproducing on optical recording media of three types having different standards, more concretely, optical recording media of HD DVD standard, DVD standard and CD standard. For the three standards, the wavelength of the laser beam used for the recording/reproducing is different therebetween, whereby the optical head unit 100 includes semiconductor lasers 101a-101c, diffraction optical elements 102a-102c, collimating lenses 103a-103c, and polarization beam splitters 104a-104c all in number of three corresponding to the respective standards.

Semiconductor laser 101a corresponds to the HD DVD standard, and emits light of around 400 nm. Semiconductor laser 101b corresponds to the DVD standard, and emits light of around 650 nm. Semiconductor laser 101c corresponds to the CD standard, and emits light of around 780 nm. If the disk 111 is an optical recording medium of HD DVD standard, semiconductor laser 101a is turned ON whereby recording/reproducing is performed using a laser beam of 400 nm. If the disk 111 is an optical recording medium of DVD standard, semiconductor laser 101b is turned ON whereby recording/reproducing is performed using a laser beam of 650 nm. If the disk 111 is an optical recording medium of CD standard, semiconductor laser 101c is turned ON whereby recording/reproducing is performed using a laser beam of 780 nm.

The 400-nm laser beam emitted from semiconductor laser 101a is divided by diffractive optical element 102a into three lights including zero-order diffracted light and ±first-order diffracted lights. The transmittance of diffraction optical element 102a with respect to the zero-order diffracted light is about 87.5%, and the diffraction efficiency of the ±first-order diffracted lights is about 5%. These lights are collimated by collimating lens 103a, are incident onto polarization beam splitter 104a as S-polarized lights, almost completely pass through the same, and are reflected by the mirror 105. The lights reflected by the mirror 105 pass through the concave lens 106 and convex lens 107, are converted from linearly-polarized lights into circularly-polarized lights by the ¼-wavelength plate 108, pass through the numerical-aperture control element 109, and are focused by the objective lens 110 onto the disk 111 that is an optical recording medium of HD DVD standard.

The 650-nm laser beam emitted from semiconductor laser 101b is divided by diffraction optical element 102b into three lights including zero-order diffracted light and ±first-order diffracted lights. The transmittance of diffraction optical element 102b with respect to the zero-order diffracted light is about 87.5%, and the diffraction efficiency of the ±first-order diffracted lights is about 5%. These lights are collimated by collimating lens 103b, are incident onto polarization beam splitter 104b as S-polarized lights, almost completely pass through the same, and are reflected by the mirror 105. The lights reflected by the mirror 105 pass through the concave lens 106 and convex lens 107, converted from linearly-polarized lights into circularly-polarized lights by the ¼-wavelength plate 108, passes through the numerical-aperture control element 109, and are focused by the objective lens 110 onto the disk 111 that is the optical recording medium of DVD standard.

The 780-nm laser beam emitted from semiconductor laser 101c is divided by diffraction optical element 102c into three lights including zero-order diffracted light and ±first-order diffracted lights. The transmittance of diffraction optical element 102c with respect to the zero-order diffracted light is about 87.5%, and the diffraction efficiency of the ±first-order diffracted lights is about 5%. These lights are collimated by collimating lens 103c, are incident onto polarization beam splitter 104c as S-polarized lights, almost completely pass through the same, and are reflected by the mirror 105. The lights reflected by the mirror 105 pass through the concave lens 106 and convex lens 107, are converted by the ¼-wavelength plate 108 from linearly-polarized lights into circularly-polarized light, pass through the numerical-aperture control element 109, and are focused by the objective lens 110 onto the disk 111 that is an optical recording medium of CD standard.

The optical path through which the lights reflected by the disk 111 are detected by the photodetector 115 is the same for the case of turn ON of semiconductor laser 101a, for the case of turn ON of semiconductor laser 101b and for the case of turn ON of semiconductor laser 101c. More specifically, the reflected lights from the disk 111 pass through the objective lens 110 and numerical-aperture control element 109 in the backward direction, are converted by the ¼-wavelength plate 108 from the circularly-polarized lights into linearly-polarized lights having a polarization direction that is perpendicular to the polarization direction of the forward-path lights, pass through the convex lens 107 and concave lens 106 in the backward direction, and are reflected by the mirror 105. The lights reflected by the mirror 105 are incident onto the polarization beam splitter 104c, 104b, or 104a as P-polarized lights, almost completely pass through the same, pass through the cylindrical lens 112, convex lens 113 and transmittance adjustment element 114, and are received by the photodetector 115.

For the HD DVD standard, DVD standard and CD standard, the thickness of the protective layer of the optical recording medium differs depending on the standards, in addition to the difference in the wavelength of light used in the recording/reproducing. For the HD DVD standard and DVD standard, the thickness of the protective layer is 0.6 mm, whereas the thickness of the protective layer is 1.2 mm for the CD standard. The difference in the wavelength of light and thickness of the protected layer that is caused by the different type of the optical recording medium causes a change of spherical aberration in the optical head unit. A larger spherical aberration causes a disturbance of the shape of focused spot that can be formed on the optical recording medium, whereby correct recording and reproducing cannot be performed. Therefore, it is needed to correct the spherical aberration depending on the type of the optical recording medium in the optical head unit that performs recording and reproducing on the optical recording media of a plurality of types having different standards.

In the optical head unit 100, the spherical aberration is corrected by the concave lens 106 and convex lens 107. More specifically, if the distance between the concave lens 106 and the convex lens 107 is changed, the magnification factor of the objective lens 110 is changed, whereby the spherical aberration in the objective lens 110 is changed. The distance between the concave lens 106 and the convex lens 107 is adjusted depending on the type of the optical recording medium to thereby cancel the spherical aberration that changes depending on the type of the optical recording medium by the spherical aberration in the objective lens 110.

For the HD DVD standard, DVD standard and CD standard, the numerical aperture of the objective lens differs thereamong. More concretely, for the HD DVD standard, the numerical aperture of the objective lens is 0.65, whereas for the DVD standard, the numerical aperture of the objective lens is 0.6. For the CD standard, the numerical aperture of the objective lens is 0.45. If the numerical aperture of the objective lens is deviated from a desired value, the focused spot formed on the optical recording medium has a size different from a desired value thereof, whereby a correct recording/reproducing cannot be performed. Thus, in the optical head unit that performs recording and reproducing on the optical recording media of a plurality of types and having different standards, it is needed to change the numerical aperture of the objective lens depending on the type of the optical recording medium.

The numerical aperture of the objective lens 110 is controlled in the optical head unit by using the numerical-aperture control element 109. The numerical-aperture control element 109 is an element having the function of changing the numerical aperture of the objective lens 110 depending on the wavelength of incident light. The configuration of numerical-aperture control element 109 is described in, for example, Patent Publication-2. By using such an element, a numerical aperture depending on the type of optical recording medium can be obtained for the objective lens 110 corresponding to the recording and reproducing on the optical recording medium.

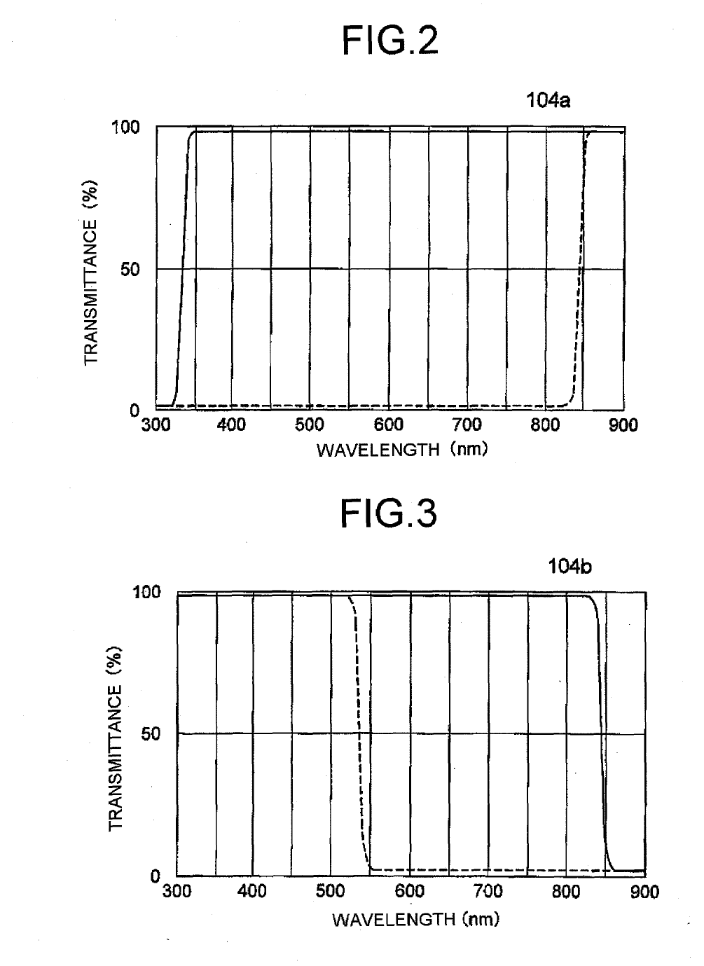

The polarization-beam splitters 104a-104c have a configuration obtained by sandwiching an optical thin film between glasses, and configures a light isolation member that isolates light emitted from the semiconductor lasers 101a-101c from the reflected light from the disk 111. FIGS. 2 to 4 show a wavelength dependency of the optical transmittance of the polarization beam splitters 104a-104c. The solid line in those figures represents the transmittance with respect to P-polarized light components, whereas the dotted line represents the transmittance with respect to the S-polarized lights.

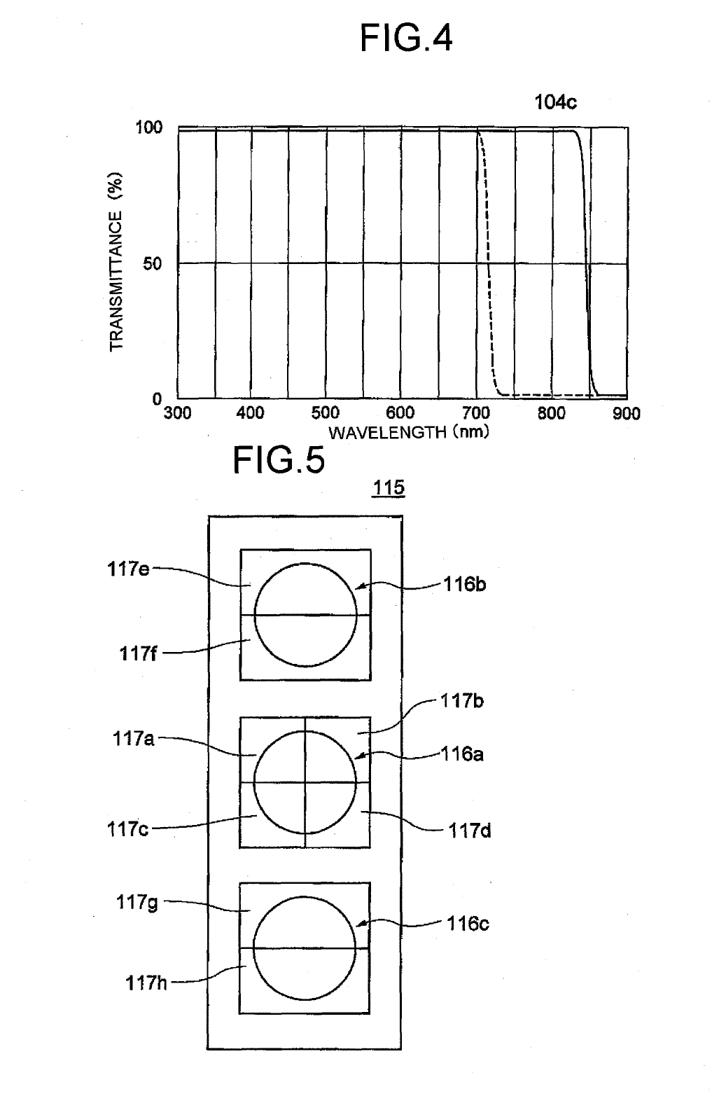

As shown in FIG. 2, polarization beam splitter 104a almost completely passes therethrough the P-polarized light component and almost completely reflects therefrom the S-polarized light component, with respect to any of 400-nm-, 650-nm-, and 780-nm-wavelength lights. As shown in FIG. 3, polarization beam splitter 104b almost completely passes therethrough both the P-polarized light component and S-polarized light component, with respect to a 400-nm-wavelength light, and almost completely passes therethrough the P-polarized light component and almost completely reflects therefrom the S-polarized light component, with respect to 650-nm- and 780-nm-wavelength lights. As shown in FIG. 4, polarization beam splitter 104c almost completely passes therethrough both the P-polarized light component and S-polarized light component, with respect to 400-nm- and 650-nm-wavelength lights, and almost completely passes therethrough the P-polarized light component and almost completely reflects therefrom the S-polarized light component, with respect to a 780-nm-wavelength light.

FIG. 5 shows the pattern of light receiving parts of the photodetector 115, and arrangement of the optical spots on the photodetector 115. The photodetector 115 is provided at the midpoint of the two focal points formed by the cylindrical lens 112 and convex lens 113. Optical spot 116a formed on the photodetector 115 corresponds to the zero-order diffracted light from either one of the diffraction optical elements 102a-102c, and is formed on the four light receiving parts 117a-117d that are partitioned by a partition line corresponding to the tangential direction (direction parallel to the information track) of the disk 111, and another partition line corresponding to the radial direction (direction perpendicular to the information track) of the disk 111.

Optical spot 116b corresponds to the +first-order diffracted light from either one of the diffraction optical elements 102a-102c. Optical spot 116b is formed on two light receiving parts 117e, 117f partitioned from each other by a partition line corresponding to the radial direction of the disk 111. Optical spot 116c corresponds to the -first-order diffracted light from either one of the diffraction optical elements 102a-102c. Optical spot 116c is formed on two light receiving parts 117g, 117h partitioned from each other by a partition line corresponding to the radial direction of the disk 111. The optical spots 116a-116c are such that the light intensity distribution corresponding to the tangential direction of the disk 111 and the light intensity distribution corresponding to the radial direction are interchanged therebetween by the function of the cylindrical lens 112 and convex lens 113 from the lights that are incident onto the cylindrical lens 112 and convex lens 113.

Assuming that V117a-V117h represent the level of voltage signals output from the light receiving parts 117a-117h, respectively, the focus error signal is detected using an astigmatic technique from the calculation of (V117a+V117d)−(V117b+V117c). If the disk 111 is a read-only disk, the tracking error signal is detected using a phase difference technique from the phase difference between (V117a+V117d) and (V117b+V 117c). If the disk 111 is a write-once disk or a rewritable disk, the tracking error signal is detected by a differential push-pull technique from the calculation of:

(V117a+V117b)−(V117+V117d)−K×[(V117e+V117g)−(V117f+V117h)],

where K is a constant. The RF signal, which includes mark/space signals recorded on the disk 111, is detected from the high frequency component of (V117a+V117b+V117c+V117d).

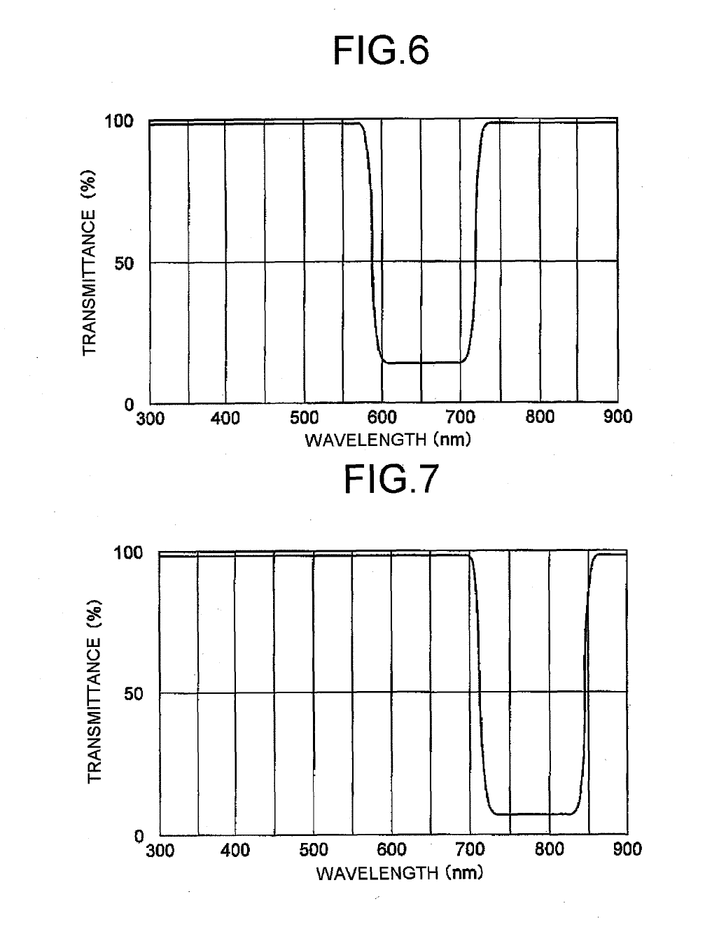

The transmittance adjustment element 114 is configured as the efficiency adjustment member. The transmittance adjustment element 114 is such that a first optical thin film 141 that is a first partial-efficiency adjustment member is formed on one of the surfaces of a glass substrate, and a second optical thin film 142 that is a second partial-efficiency adjustment member is formed on the other of the surfaces thereof. FIGS. 6 and 7 show wavelength dependencies of transmittance of the first and second optical thin films 141 and 142, respectively, formed in the transmittance adjustment element 114. As shown in FIG. 6, the first optical thin film is designed so that the transmittance with respect to 400-nm- and 780-nm-wavelength lights is about 100%, and the transmittance with respect to a 650-nm-wavelength light is about 13%. As shown in FIG. 7, the second optical thin film is designed so that the transmittance with respect to 400-nm- and 650-nm-wavelength lights is about 100%, and the transmittance with respect to a 780-nm-wavelength light is about 7.5%. As a result, the total transmittance of the transmittance adjustment element 114 is about 100% with respect to a 400-nm-wavelength light, about 13% with respect to a 650-nm-wavelength light, and about 7.5% with respect to a 780-nm-wavelength light.

The first and second optical thin films 141 and 142 as described above are band-limiting filters each of which has a lower transmittance within a specific frequency range having a specific wavelength of λ as the central wavelength thereof, and a substantially 100% transmittance other than the specific frequency range. Such a band-limiting filter can be realized by alternately stacking higher-refractive-index layers including a material of titanium dioxide, for example, and lower-refractive-index layers including a material of silicon dioxide, for example, so that each layer has an optical thickness of λ/4. If the thickness of each layer is changed, the central wavelength of the wavelength range having a lower transmittance is changed, whereas if the total number of the stacked layers is changed, the transmittance with respect to the central wavelength is changed. Accordingly, a suitable design of the thickness of each layer and the total number of the layers can provide a desired value of the central wavelength of the wavelength range that provides a lower transmittance and the transmittance with respect to the central wavelength.

Assuming here that the optical recording medium is a read-only optical recording medium, the typical optical reflectance of the optical recording medium of each standard is about 21% if the optical recording medium is of HD DVD standard, about 65% if the optical recording medium is of DVD standard, and about 80% if the optical recording medium is of CD standard. In addition, the typical reproducing power is about 0.5 mW if the optical recording medium is of HD DVD standard, about 0.7 mW if the optical recording medium is of DVD standard, and about 1W if the optical recording medium is of CD standard. Assuming that the photoelectric conversion efficiency of the photodetector is the ratio of the level of current signal generated in the photodetector to the intensity of light incident onto the photodetector 115, the photoelectric conversion efficiency depends on the wavelength of light incident onto the photodetector 115, and is about 0.23 mA/mW for a 400-nm-wavelength light, about 0.4 mA/mW for a 650-nm-wavelength light, and about 0.4 mA/mW for a 780-nm-wavelength light.

It is further assumed that the IV conversion gain of the photodetector is the ratio of the level of voltage signal output from the photodetector 115 to the level of current signal generated in the photodetector 115, and the IV conversion gain in each of the light receiving parts 117a-117d of photodetector 115 during the reproducing is 100 V/mA. In this case, the level of voltage signals output from the light receiving parts 117a-117d of the photodetector 115 during the reproducing is expressed by:

(typical reproducing power of optical recording medium)×(typical reflectance of optical recording medium)×(transmittance of transmittance adjustment element)×(photoelectric conversion efficiency of photodetector)×(IV conversion gain of photodetector)÷4.

If the reproducing is performed on an optical recording medium of HD DVD standard by using a 400-nm-wavelength light, the above value is obtained by:

0.5 mW×0.21×1×0.23 mA/mW×100 V/mA÷4=0.6V.

If the reproducing is performed on an optical recording medium of DVD standard by using a 650-nm-wavelength light, the above value is obtained by:

0.7 mW×0.65×0.13×0.4 mA/mW×100 V/mA÷4=0.6V.

If the reproducing is performed on an optical recording medium of CD standard by using a 780-nm-wavelength light, the above value is obtained by:

1 mW×0.8×0.075×0.4 mA/mW×100 V/mA÷4=0.6V.

That is, use of the transmittance adjustment element 114 that is the efficiency adjustment member allows the levels of voltage signals output from the photoreceiving parts 117a-117d of the photodetector 115 during the reproducing to be equal to one another with respect to the optical recording media of the HD DVD standard, DVD standard and CD standard, irrespective of the types of the optical recording media.

It is preferable that the levels of voltage signals output from the light receiving parts 117e-117h of the photodetector 115 during the reproducing be equal to the levels of the voltage signals output from the optical receiving parts 117a-117d, respectively, of the photodetector 115 during the reproducing, in order for preventing a reduction in the signal-to-noise ratio of the voltage signal after amplification by a subsequent-stage amplifier or a saturation of the voltage signal after the amplification. For satisfying this condition, it is sufficient that the IV conversion gain of the optical receiving parts 117e-117h of the photodetector 115 be 875 V/mA, in consideration that the transmittance of diffraction optical elements 102a-102c with respect to the zero-order diffracted light is about 87.5%, that the diffraction efficiency of the ±first-order diffracted lights is about 5%, that optical spot 116a is formed on the four light receiving parts, and that optical spots 116b and 116c are each formed on the two light receiving parts. Further, it is preferable that the levels of the voltage signals output from the light receiving parts 117e-117h during the reproducing be equal to the levels of the voltage signals output from the light receiving parts 117a-117d, respectively, during the reproducing, in order for preventing a reduction in the signal-to-noise ratio of the voltage signals after amplification by a subsequent-stage preamplifier or a saturation of the voltage signal after the amplification. For satisfying this condition, it is sufficient that the IV conversion gain of the light receiving parts 117a-117d during the reproducing be 6.67 V/mA and the IV conversion gain of the light receiving parts 117e-117h during the reproducing be 58.3 V/mA, in consideration that the typical ratio of the recording power to the reproducing power is about 15 in the optical recording medium.

In the present embodiment, the transmittance adjustment element 114 is configured by a combination of the first partial-efficiency adjustment member that causes the transmittance with respect to a 650-nm-wavelength light to be lower than the transmittance with respect to the lights of other two wavelengths, the second partial-efficiency adjustment member that causes the transmittance with respect to a 780-nm-wavelength light to be lower than the lights of the other two wavelengths. In this way, the backward-path efficiency with respect to the lights of three wavelengths including the first through third wavelengths can be adjusted to a desired value for each of the wavelengths. Thus, the intensity of light incident onto the photodetector 115 or the level of voltage signal output from the photodetector during the recording or reproducing can be made constant for the optical recoding media of the three different standards, irrespective of the types of the optical recording media.

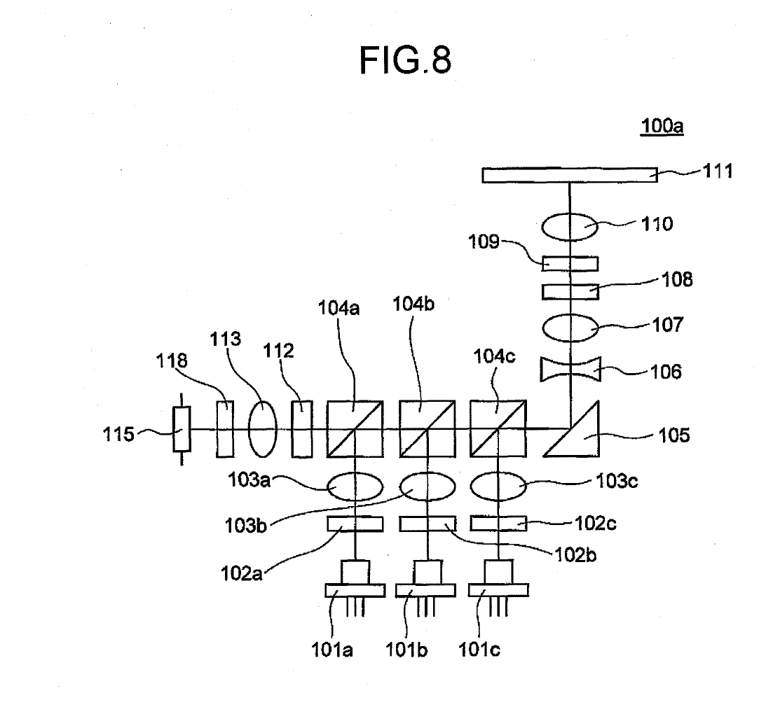

FIG. 8 shows the configuration of an optical head unit according to a second exemplary embodiment of the present invention. The optical head unit 100a of the present embodiment is different from the optical head unit 100 of the first exemplary embodiment in that the former includes another transmittance adjustment element 118 instead of the transmittance adjustment element 114 (FIG. 1). In the first exemplary embodiment, the transmittance adjustment element 114 (FIG. 1) including the optical thin film is used as an efficiency adjustment member. The present embodiment uses the transmittance adjustment element 118 including partial-efficiency adjustment members each configured by a wavelength plate and a diffraction grating.

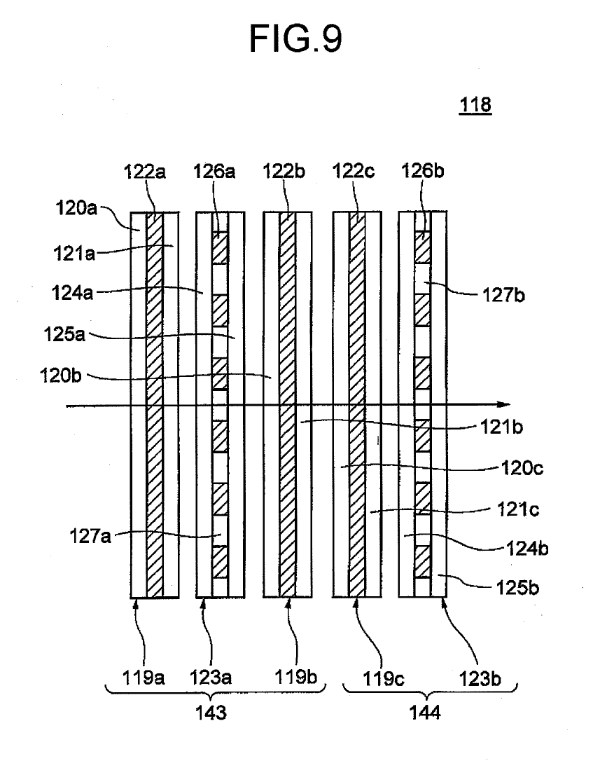

FIG. 9 shows the sectional structure of the transmittance adjustment element 118. The transmittance adjustment element 118 is configured by stacking a wavelength plate 119a, a diffraction grating 123a, a wavelength plate 119b, a wavelength plate 119c, and a diffraction grating 123b one on another. Wavelength plate 119a, diffraction grating 123a, and wavelength plate 119b configure a first partial-efficiency adjustment member 143.

Wavelength plate 119c and diffraction grating 123b configure a second partial-efficiency adjustment member 144. Wavelength plate 119a is configured by sandwiching a liquid crystal polymer 122a having a birefringence between a substrate 120a and a substrate 121a. Wavelength plate 119b is configured by sandwiching a liquid crystal polymer 122b having a birefringence between a substrate 120b and a substrate 121b. Wavelength plate 119c is configured by sandwiching a liquid crystal polymer 122c having a birefringence between a substrate 120c and a substrate 121c.

Diffraction grating 123a has a configuration wherein a cyclic pattern of liquid crystal polymer 126a having a birefringence and filling agents 127a without having a birefringence is formed between a substrate 124a and a substrate 125a. Diffraction grating 123b also has a configuration wherein a cyclic pattern of liquid crystal polymer 126b having a birefringence and filling agents 127b without having a birefringence is formed between a substrate 124b and a substrate 125b.

Wavelength plates 119a and 119b act as an all-wavelength plate with respect to 400-nm- and 780-nm-wavelength lights, and act as a ½-wavelength plate with respect to a 650-nm-wavelength light that rotates the polarization of incident light by 90 degrees. Such a wavelength plate can be realized by allowing the phase difference between an ordinary light component and an extraordinary light component in the liquid crystal polymer 122a, 122b to assume an integral multiple of 2 π with respect to 400-nm- and 780-nm-wavelength lights, and assume an odd-number multiple of π with respect to a 650-nm-wavelength light. For example, if the phase difference between the ordinary light component and the extraordinary light component in the liquid crystal polymer 122a, 122b is (2 π/)×1600 nm (where λ is the wavelength of incident light), the above relationship is substantially satisfied because the phase difference assumes 2 π×4 for the case of λ=400 nm, assumes 2 π×2.05 for the case of λ=780 nm, and assumes π×4.92 for the case of λ=650 nm.

Wavelength plate 119c acts as an all-wavelength plate with respect to 400-nm- and 650-nm-wavelength lights, and acts as a ½-wavelength plate with respect to a 780-nm-wavelength light that rotates the polarization direction of incident light by 90 degrees. Such a wavelength plate can be realized by a configuration wherein the phase difference between the ordinary light component and the extraordinary light component across the liquid crystal polymer 122c assumes an integral multiple of 2 π with respect to the 400-nm- 650-nm-wavelength lights, and assumes an odd-number multiple of it with respect to the 780-nm-wavelength light. For example, assuming that the phase difference between the ordinary light component and the extraordinary light component across the liquid crystal polymer 122c is (2 π)×2000 nm (λ is the wavelength of incident light), the phase difference is 2 π×5 in the case of λ=400 nm, 2 π×3.08 in the case of λ=650 nm, and π×5.13 in the case of λ=780 nm, whereby the above condition is satisfied.

The longitudinal direction of the liquid crystal polymer 126a and 126b in the diffraction gratings 123a and 123b is perpendicular to the sheet of FIG. 9. Assuming that a linearly-polarized light having a polarization direction perpendicular to the sheet of FIG. 9 is a TE-polarized light and a linearly-polarized light having a polarization direction parallel to the sheet of FIG. 9 is a TM-polarized light, and that nₑ and nₒ are the refractive indexes of the liquid crystal polymer 126a, 126b with respect to the TE-polarized light (extraordinary light) and TM-polarized light (ordinary light), respectively, the relationship nₑ−nₒ=0.25 holds. On the other hand, the refractive index of filling agents 127a, 127b is nₒ with respect to any of the TE-polarized light and TM-polarized light.

The sectional shape of the cyclic pattern in the diffraction grating 123a, 123b is a rectangular shape wherein the width of the liquid crystal polymer is equal to the width of the filling agent, and the direction and pitch of the cyclic pattern are determined so that the diffracted light is not incident onto the light receiving parts 117a-117h of the photodetector 115. Assuming that “t” is the thickness of the liquid crystal polymer and filling agent, and φ and λ are the phase difference generated between the liquid crystal polymer and the filling agent and the wavelength of the incident light, respectively, the relationship ∠=2 π (nₑ−nₒ) t/λ holds with respect to the TE-polarized light, and φ=0 holds with respect to the TM-polarized light. In this case, the transmittance of the diffraction gratings 123a, 123b is expressed by cos²(φ/2). If t=0.99 μm in diffraction grating 123a, the transmittance with respect to the TE-polarized light in the case of λ=650 nm is about 13%. If t=1.28 μm in diffraction grating 123b, the transmittance with respect to the TE-polarized light in the case of λ=780 nm is about 7.5%. The transmittance with respect to the TM-polarized light in the diffraction gratings 123a, 123b is substantially 100% irrespective of the wavelength.

The 400-nm- and 780-nm-wavelength lights are incident onto the wavelength plate 119a as TM-polarized lights, and exit therefrom as the TM-polarized lights without a change. Thereafter, these lights are incident onto diffraction grating 123a as the TM-polarized lights, and exits therefrom substantially at 100%. On the other hand, the 650-nm-wavelength light is incident onto wavelength plate 119a as a TM-polarized light, and converted into a TE-polarized light to exit therefrom. This light is incident onto diffraction grating 123a as a TE-polarized light, and passes therethrough at about 13%. Thereafter, it is incident onto wavelength plate 119b as the TE-polarized light, and converted into a TM-polarized light to exit therefrom. That is, the first partial-efficiency adjustment member has the function of passing therethrough 400-nm- and 780-nm wavelength lights at about 100%, and passing therethrough a 650-nm-wavelength light at about 13%.

The 400-nm- and 650-nm-wavelength lights are incident onto wavelength plate 119c as TM-polarized lights, and exit therefrom as the TM-polarized lights without a change. These lights are incident onto diffraction grating 123b as the TM-polarized lights, and pass therethrough at about 100%. On the other hand, a 780-nm-wavelength light is incident onto wavelength plate 119c as a TM-polarized light, and converted into a TE-polarized light to exit therefrom. This light is incident onto diffraction grating 123b as the TE-polarized light, and pass therethrough at about 7.5% That is, the second partial-efficiency adjustment member has the function of passing therethrough the 400-nm- and 650-nm-wavelength lights at about 100%, and passes therethrough a 780-nm-wavelength light at about 7.5%. As a result, the overall transmission of the transmittance adjustment element 118 that is an efficiency adjustment member is about 100% with respect to the 400-nm-wavelength light, about 13% with respect to the 650-nm-wavelength light, and about 7.5% with respect to the 780-nm-wavelength light.

In the present embodiment, the first and second partial-efficiency adjustment members 143 and 144 are configured by using wavelength plates that rotate the polarization direction of a light having a specific wavelength and diffraction gratings that have the function of reducing the transmittance with respect to a light having a specific polarization direction. Even in the case of using such a configuration, as in the first embodiment, the backward-path efficiency with respect to lights having the first and third wavelengths can be adjusted at a desired value for each of the wavelengths, whereby the level of voltage signals output from the photodetector 115 is fixed constant irrespective of the type of optical recording medium.

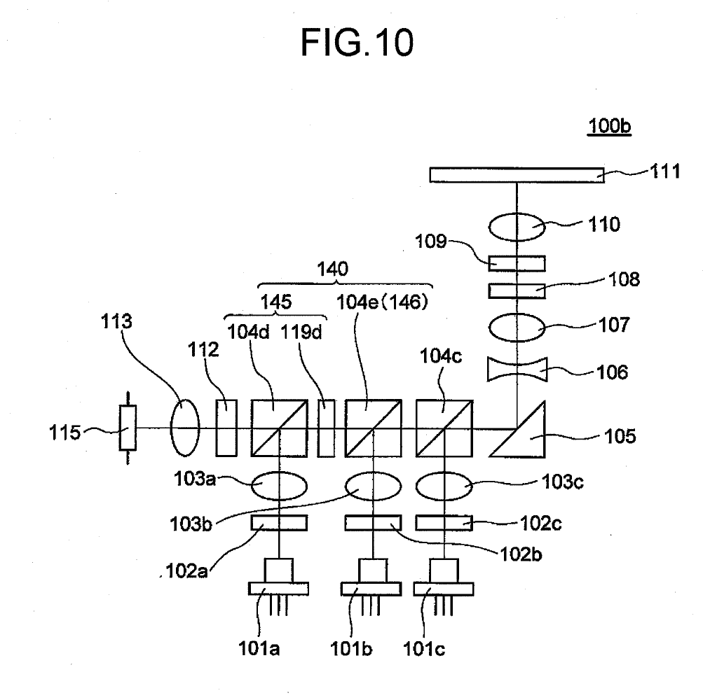

FIG. 10 shows the configuration of an optical head unit according to a third exemplary embodiment of the present invention. The optical head unit 100b of the present embodiment has a configuration wherein polarization beam splitters 104a, 104b in FIG. 1 are replaced by polarization beam splitters 104d, 104e, respectively, a wavelength plate 119d is inserted between polarization beam splitter 104d and polarization beam splitter 104e, and the transmittance adjustment element 114 is eliminated. In the present embodiment, wavelength plate 119d and polarization beam splitter 104d configure the first partial-efficiency adjustment member 145, and polarization beam splitter 104e configures the second partial-efficiency adjustment member 146. The efficiency adjustment member 140 is configured by a combination of these partial-efficiency adjustment members 145, 146.

Wavelength plate 119d is configured by sandwiching a liquid crystal polymer having a birefringence between two substrates similarly to the wavelength plates 119a and 119b shown in FIG. 9. Wavelength plate 119d acts as an all-wavelength plate with respect to 400-nm- and 780-nm-wavelength lights, and acts as a ½-wavelength plate with respect to a 650-nm-wavelength light that rotates the polarization direction of incident light by 90 degrees. Polarization beam splitters 104d and 104e have a configuration wherein an optical thin film is sandwiched between glasses, and configure, in association with polarization beam splitter 104c, an optical isolation member that isolates the light that exits from the semiconductor lasers 101a-101c and the light reflected by the disk 111 from each other.

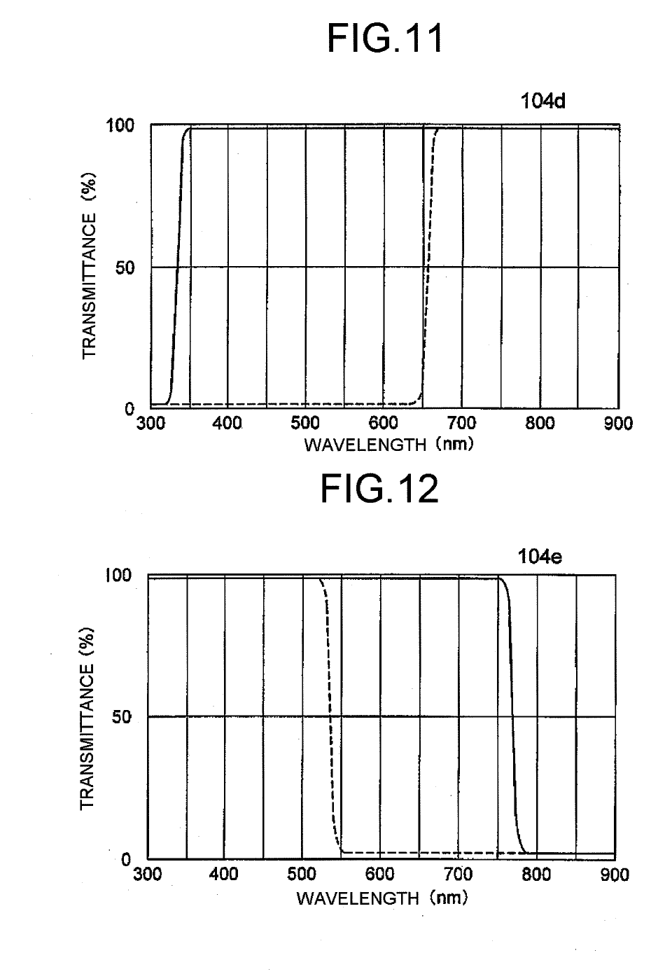

FIGS. 11 and 12 show a wavelength dependency of the transmittance of polarization beam splitters 104d and 104e, respectively. The solid line in the figures shows the transmittance with respect to a P-polarized light component, and a dotted line therein shows the transmittance with respect to a S-polarized light component. As shown in FIG. 11, polarization beam splitter 104d almost completely passes therethrough the P-polarized light component with respect to the 400-nm-wavelength light, and almost completely reflects therefrom the S-polarized light component. In addition, it almost completely passes therethrough the P-polarized light component and passes therethrough the S-polarized light component at about 13%, with respect to the 650-nm-wavelength light. It also completely passes therethrough both the P-polarized light component and S-polarized light component with respect to the 780-nm-wavelength light.

As shown in FIG. 12, polarization beam splitter 104e almost completely passes therethrough both the P-polarized light component and S-polarized light component with respect to the 400-nm-wavelength light, passes therethrough the P-polarized light component and almost completely reflects therefrom the S-polarized light component, with respect to the 650-nm-wavelength light. It also passes therethrough the P-polarized light component at about 7.5% and almost completely reflects therefrom the S-polarized light component, with respect to the 780-nm-wavelength light.

A 400-nm-wavelength light that exits from semiconductor laser 101a is incident onto polarization beam splitter 104d as a S-polarized light, almost completely reflected therefrom, and passes through wavelength plate 119d as a linearly-polarized light with the polarization direction thereof being unchanged. Thereafter, the light is incident onto polarization beam splitter 104e as a S-polarized light, and almost completely passes through the same, to advance toward the disk 111. A 650-nm-wavelength light that exits from semiconductor laser 101b is incident onto polarization beam splitter 104e as a S-polarized light, and almost completely reflected therefrom, to advance toward the disk 111. A light that exits from semiconductor laser 101c is similar to that described in the first exemplary embodiment.

A 400-nm-wavelength light reflected from the disk 111 is incident onto polarization beam splitter 104e as a P-polarized light, almost completely pass through the same, and passes through wavelength plate 119d as a linearly-polarized light with the polarization direction thereof being unchanged. Thereafter, the light is incident onto polarization beam splitter 104d as a P-polarized light, almost completely passes through the same, to advance toward the photodetector 115. A 650-nm-wavelength light reflected from the disk 111 is incident onto polarization beam splitter 104e as a P-polarized light, and almost completely passes therethrough, and passes through wavelength plate 119d as a linearly polarized light having a polarization direction rotated by 90 degrees. Thereafter, the light is incident onto polarization beam splitter 104d as a S-polarized light, and passes through the same at about 13%, to advance toward the photodetector 115.

A 780-nm-wavelength light reflected from the disk 111 is incident onto polarization beam splitter 104e as a P-polarized light, passes through the same at about 7.5%, and passes through wavelength plate 119d as a linearly-polarized light with the polarization direction thereof being unchanged. Thereafter, the light is incident onto polarization beam splitter 104d as a P-polarized light, and almost completely passes through the same, and advances toward the photodetector 115. That is, the first partial-efficiency adjustment member has the function of passing therethrough the 400-nm- and 780-nm- wavelength lights at about 100%, and passing therethrough the 650-nm-wavelength light at about 13%. The second partial-efficiency adjustment member has the function of passing therethrough the 400-nm- and 650-nm-wavelength lights at about 100%, and passing therethrough the 780-nm-wavelength light at about 7.5%. As a result, the transmittance of the efficiency adjustment member configured by a combination of them is about 100% with respect to the 400-nm-wavelength light, about 13% with respect to the 650-nm-wavelength light, and about 7.5% with respect to the 780-nm-wavelength light.

The polarization beam splitters 104d and 104e have a first wavelength range within which both the P-polarized light component and S-polarized light component are almost completely passed thereby, a second wavelength range within which the P-polarized light component is almost completely passed thereby and the S-polarized light component is almost completely reflected therefrom, and a third wavelength range within which both the P-polarized light component and S-polarized light component are almost completely reflected therefrom. Such a polarization beam splitter is realizable by, for example, alternately stacking higher-refractive-index layers including a material of titanium dioxide and lower-refractive-index layers including a material of silicon dioxide so that each layer has a constant optical thickness. If the thickness of each layer or the total number of layers is changed, the boundary wavelength between the first wavelength range and the second wavelength as well as the boundary wavelength between the second wavelength range and the third boundary wavelength is changed. Thus, a suitable design of the thickness of each layer and the total number of layers provides a desired value for the boundary wavelength between the first wavelength range and the second wavelength range as well as the boundary wavelength between the second wavelength range and the third wavelength range.

Polarization beam splitter 104d is designed such that the 400-nm wavelength is included in the second wavelength range, the 650-nm wavelength is in the vicinity of the boundary wavelength between the first wavelength range and the second wavelength range, and the 780-nm wavelength is included in the first wavelength range. Polarization beam splitter 104e is designed such that the 400-nm wavelength is included in the first wavelength range, the 650-nm wavelength is included in the second wavelength range, and the 780-nm wavelength is in the vicinity of the boundary wavelength between the second wavelength range and the third wavelength range.

In the present embodiment, the polarization beam splitters 104d and 104e each include an optical thin film having a transmittance that depends on the wavelength and polarization direction, and the optical isolation member that isolates the forward-path light advancing from the semiconductor lasers 101a-101c toward the objective lens 110 and the backward-path light advancing from the disk 111 to the photodetector 115 from each other also acts as an efficiency adjustment member that changes the backward-path efficiency depending on the wavelength. Also in this case, as in the first embodiment, the backward-path efficiency with respect to the lights of three wavelengths including the first through third wavelengths can be adjusted to a desired value for each of the wavelengths, whereby the intensity of light that is incident onto the photodetector 115 during the recording and reproducing, or the level of voltage signal output from the photodetector 115 can be fixed constant irrespective of the type of optical recording medium.

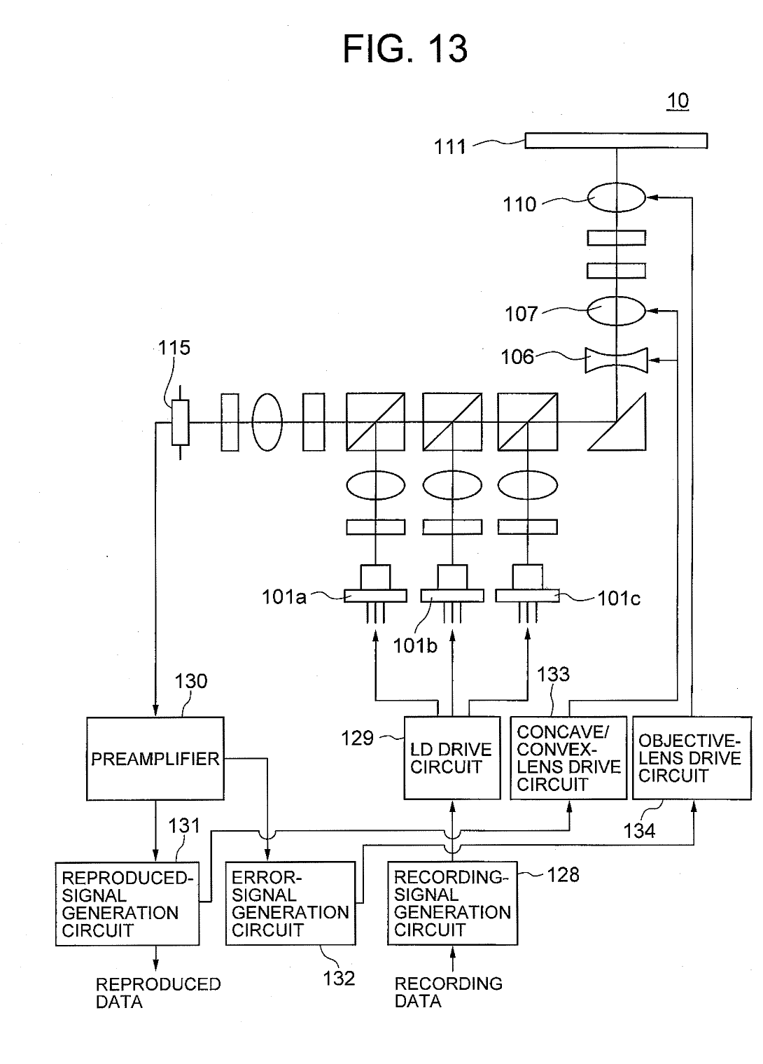

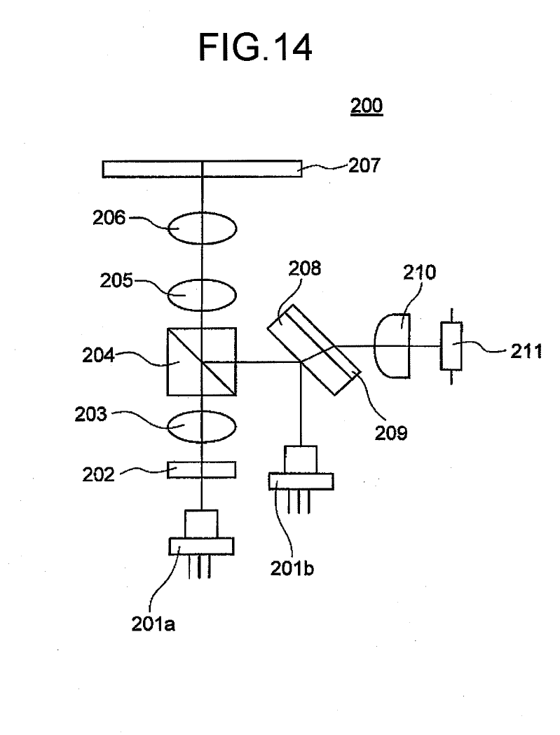

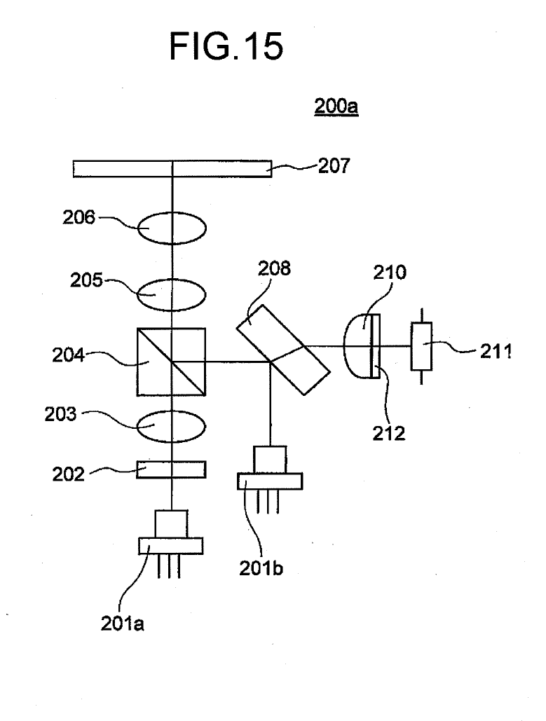

An optical information recording/reproducing apparatus including the optical head unit of the present invention will be described. FIG. 13 shows the configuration of an optical information recording/reproducing apparatus including the optical head unit of the first exemplary embodiment of the present invention. The optical information recording/reproducing apparatus 10 includes, in addition to the optical head unit 100 shown in FIG. 1, a recording-signal generation circuit 128, a semiconductor-laser (LD) drive circuit 129, a preamplifier 130, a reproduced-signal generation circuit 131, an error-signal generation circuit 132, a concave/convex-lens drive circuit 133, and an objective-lens drive circuit 134.

The recording-signal generation circuit 128 generates, based on the recording data input from the outside, a recording signal for selectively driving the semiconductor lasers 101a-101c in the optical head unit 100 depending on a recording strategy. Based on the recording signal generated in the recording-signal generation circuit 128, the semiconductor-laser drive circuit 129 supplies current corresponding to the recording signal to one of the semiconductor lasers 101a-101c, to selectively drive the semiconductor lasers 101a-101c. Thus, recording of data is performed on the disk 111.

The preamplifier 130 amplifies the voltage signal output from each of the light receiving parts of the photodetector 115. The reproduced-signal generation circuit 131 generates, based on the voltage signal amplified by the preamplifier 130, an RF signal including mark/space signals recorded on the disk 111, for driving the concave lens 106 or convex lens 107, and outputs the reproduced data to the outside. Thus, reproducing of data from the disk 111 is performed.

Based on the RF signal generated in the reproduced-signal generation circuit 131, the concave/convex-lens drive circuit 133 supplies current to a motor not illustrated, to drive the concave lens 106 or convex lens 107 so that the RF signal has the best quality. Thus, correction of the spherical aberration that depends on the type of disk 111 is performed. The error-signal generation circuit 132 generates a focus error signal and a tracking error signal for driving the objective lens 110, based on the voltage signal amplified by the preamplifier 130.

Based on the focus error signal and tracking error signal generated in the error-signal generation circuit 132, the objective-lens drive circuit 134 supplies current to an actuator not illustrated, to drive the objective lens 110 so that the focus error signal and tracking error signal assume zero. Thus, focus-servo and tracking-servo operations are performed. The optical head unit 100 is driven as a whole in the radial direction of the disk 111 by a positioner not illustrated, and the disk 111 is driven for rotation by a spindle not illustrated. Thus, the focus, tracking, positioner and spindle servos are performed.

Although an example is described that the optical head unit 100 of the first exemplary embodiment is mounted as an optical head unit, the optical head unit 100a (FIG. 8) of the second exemplary embodiment or optical head unit 100b (FIG. 10) of the third exemplary embodiment may be mounted. Although the description is provided with respect to a recording/reproducing apparatus that performs the recording and reproducing on the disk 111, a read-only apparatus may be used therein. In this case, the semiconductor lasers 101a-101c are driven by the semiconductor-laser drive circuit 129 so that the power of irradiation light is fixed, and not based on the recording signal.

In the optical head unit according to the first exemplary embodiment of the present invention, the forward-path light and backward-path light having a 400-nm wavelength are isolated from each other by polarization beam splitter 104a, the forward-path light and backward-path light having a 650-nm wavelength are isolated from each other by polarization beam splitter 104b, and the forward-path light and backward-path light having a 780-nm wavelength are isolated from each other by polarization beam splitter 104c. In this case, the forward-path light of 400-nm wavelength is reflected by polarization beam splitter 104a, whereas the backward-path light passes through polarization beam splitter 104a. In the third exemplary embodiment of the present invention, the forward-path light and backward-path light having a 400-nm wavelength are isolated from each other by polarization beam splitter 104d, the forward-path light and backward-path light having a 650-nm wavelength are isolated from each other by polarization beam splitter 104e, and the forward-path light and backward-path light having a 780-nm wavelength are isolated from each other by polarization beam splitter 104c. In this case, with respect to the 400-nm-wavelength light, the forward-path light is reflected by polarization beam reflector 104d, whereas the backward-path light passes through polarization beam splitter 104d. With respect to the 650-nm wavelength, the forward-path light is reflected by polarization beam splitter 104e, whereas the backward-path light passes through polarization beam splitter 104e. With respect to the 780-nm wavelength, the forward-path light is reflected by polarization beam splitter 104c, whereas the backward-path light passes through polarization beam splitter 104c. Differently from these embodiments, another embodiment may be possible wherein the forward-path light and backward-path light of each of the 400-nm, 650-nm and 780-nm wavelengths are isolated from each other by a corresponding polarization beam splitter, and the forward-path light passes through the corresponding polarization beam splitter whereas the backward-path light is reflected by the corresponding polarization beam splitter.

In the optical head unit of the above embodiments, there are provided a first partial-efficiency adjustment member that changes the backward-path efficiency with respect to a first-wavelength light relatively to the backward-path efficiency with respect to second- and third-wavelength lights, and a second partial-efficiency adjustment member that changes the backward-path efficiency with respect to the second-wavelength light relatively to the backward-path efficiency with respect to the first- and third-wavelength lights, in the backward path along which a light reflected by the optical recording medium is incident onto the photodetector. Use of such an efficiency adjustment member enables setting of the backward-path efficiency with respect to each of the first- through third-wavelength lights at a desired efficiency, whereby the intensity of light incident onto the photodetector or the level of voltage signal output from the photodetector can be fixed constant irrespective of the wavelength of light used for recording/reproducing.

As described heretofore, the optical head unit of the present invention may employ the following configurations.

There is provided, in a backward path along which a light reflected by an optical recording medium is incident onto a photodetector, an efficiency adjustment member including a first partial-efficiency adjustment member that changes the backward-path efficiency with respect to the first-wavelength light relatively to the backward-path efficiency with respect to the second- and third-wavelength lights, and a second partial-efficiency adjustment member that changes the backward-path efficiency with respect to the second-wavelength light relatively to the backward-path efficiency with respect to the first- and third-wavelength lights. Use of such an efficiency adjustment member can set the backward-path efficiency with respect to each of the first through third-wavelength lights at a desired efficiency, whereby the intensity of light incident onto the photodetector or the level of voltage signal output from the photodetector can be fixed constant irrespective of the wavelength of light used for reproducing.

A configuration may be employed wherein the efficiency adjustment member causes the backward-path efficiency with respect to a second-shortest-wavelength light among the first- through third-wavelength lights to be lower than the backward-path efficiency with respect to a shortest-wavelength light among the first- through third-wavelength lights, and causes the backward-path efficiency with respect to a longest-wavelength light among the first- through third-wavelength lights to be lower than the backward-path efficiency with respect to the second-shortest-wavelength light. For example, assuming that the backward-path efficiency is fixed constant irrespective of the wavelength, the backward-path efficiency is set as above depending on the wavelength, in the case where the intensity of light incident onto the photodetector or the level of voltage signal output from the photodetector is lowest when a shortest wavelength among the three wavelengths is used, and the intensity of light incident onto the photodetector or the level of voltage signal output from the photodetector is highest among the three wavelength when a longest wavelength among the three wavelengths is used, whereby the intensity of light incident onto the photodetector or the level of voltage signal output from the photodetector is fixed constant irrespective of the wavelength.

A configuration may be employed wherein the first and second partial-efficiency adjustment members each include an optical thin film having a transmittance or reflectance that depends on a wavelength of incident light. As the member that changes the transmission with respect to an incident light having a specific wavelength relatively to the transmission with respect to the lights of other wavelengths, an optical thin film can be employed wherein higher-refractive-index layers and lower-refractive-index layers are alternately stacked so that each layer has an optical thickness of desired value.

A configuration may be employed wherein the optical thin film of the first partial-efficiency adjustment member transmits or reflects light at a specific transmittance or reflectance with respect to the first-wavelength light, and transmits or reflects incident light as it is with respect to the second- and third-wavelength lights. In addition, a configuration may be employed wherein the optical thin film of the second partial-efficiency adjustment member transmits or reflects light at a specific transmittance or reflectance with respect to the second-wavelength light, and transmits or reflects incident light as it is with respect to the first- and third-wavelength lights. As the first and second partial-efficiency adjustment members, a band-limiting filter may be used that has, for example, a lower transmission within a specific wavelength range having the first wavelength or second wavelength as the central wavelength thereof, and passes therethrough at about 100% incident light outside the wavelength range.

A configuration may be employed wherein the first and second partial-efficiency adjustment members each include an optical thin film having a transmittance or reflectance that depends on a polarization direction and a wavelength of incident light, and also acts an optical isolation member that isolates a forward-path light that advances from the light source toward the objective lens and a backward-path light that is reflected by the optical recording medium to advance toward the photodetector, from each other.

A configuration may be employed wherein the first and second partial-efficiency adjustment members each include a diffraction grating having a transmittance that depends on a polarization direction of incident light. In this case, a wavelength plate that rotates the polarization direction of the light having a desired wavelength is disposed on the side of the partial-efficiency adjacent member onto which the backward-path light is incident, whereby the transmission with respect to the light having a specific wavelength is changed relatively to the transmission of the light having other wavelengths.

A configuration may be employed wherein the first partial-efficiency adjustment member includes: a wavelength plate that, upon receiving an incident linearly-polarized backward-path light having a specific polarization direction, passes therethrough the incident linearly-polarized light after rotating the specific polarization direction by 90 degrees with respect to the first-wavelength light, and passes therethrough the incident linearly-polarized light while maintaining the specific polarization direction with respect to the second- and third-wavelength lights; and a diffraction grating that, upon receiving an incident backward-path light via the wavelength plate, passes therethrough the incident light as it is with respect to a linearly-polarized light having the specific polarization direction, and passes therethrough the incident light at a specific transmittance with respect to a linearly-polarized light having a polarization direction 90 degrees away from the specific polarization direction. In this case, with respect to the second- and third-wavelength lights, the light incident onto the wavelength plate as a linearly-polarized light having the specific polarization direction passes through the wavelength plate as it is, to be incident onto the diffraction plate, and passes through the diffraction grating as it is. On the other hand, the first-wavelength light is incident onto the wavelength plate as a linearly-polarized light, is rotated by 90 degrees in the polarization direction by the wavelength plate to be incident onto the diffraction grating, and passes through the diffraction grating at the specific transmittance. In this way, the backward-path efficiency with respect to the first-wavelength light can be changed relatively to the efficiency with respect to the second- and third-wavelength lights.

A configuration may be employed wherein the second partial-efficiency adjustment member includes: a wavelength plate that, upon receiving an incident linearly-polarized backward-path light having a specific polarization direction, passes therethrough the incident linearly-polarized light after rotating the specific polarization direction by 90 degrees with respect to the second-wavelength light, and passes therethrough the incident linearly-polarized light while maintaining the specific polarization direction with respect to the first- and third-wavelength lights; and a diffraction grating that, upon receiving an incident backward-path light via the wavelength plate, passes therethrough the incident light as it is with respect to a linearly-polarized light having the specific polarization direction, and passes therethrough the incident light at a specific transmittance with respect to a linearly-polarized light having a polarization direction 90 degrees away from the specific polarization direction. In this case, with respect to the first- and third-wavelength lights, the light incident onto the wavelength plate as a linearly-polarized light having the specific polarization direction passes through the wavelength plate as it is, to be incident onto the diffraction grating, and passes through the diffraction grating at the specific transmission. On the other hand, the second-wavelength light is incident onto the wavelength plate as a linearly-polarized light having the specific polarization direction, is rotated by 90 degrees in the polarization direction by the wavelength plate, to be incident onto the diffraction grating, and passes through the diffraction grating at the specific transmission. In this way, the backward-path efficiency with respect to the second-wavelength light can be changed relatively to the efficiency with respect to the first- and third-wavelength lights. Note that if the first and second partial-efficiency adjacent members are to be arranged in series with respect to the backward-path light, it is sufficient that another wavelength plate that recovers the polarization direction rotated by the preceding-stage partial-efficiency adjacent member to the specific polarization direction be disposed between the incident-side (preceding-stage) partial-efficiency adjacent member and the succeeding-stage partial-efficiency adjacent member, as viewed from the backward-path light.

While the invention has been particularly shown and described with reference to exemplary embodiment thereof, the invention is not limited to these embodiments and modifications. As will be apparent to those of ordinary skill in the art, various changes may be made in the invention without departing from the spirit and scope of the invention as defined in the appended claims.

This application is based upon and claims the benefit of priority from Japanese patent application No. 2006-328490 filed on Dec. 5, 2006, the disclosure of which is incorporated herein in its entirety by reference.

1. An optical head unit comprising:
first through third light sources that emit first- through third-wavelength lights, respectively, that are different from one another in wavelength;
an objective lens that focuses lights emitted from said first through third light sources onto an optical recording medium;
a photodetector that receives a reflected light reflected by said optical recording medium;
an efficiency adjustment member disposed in an optical path of said reflected light to change a backward-path efficiency, which is a ratio of an intensity of light incident onto said photodetector to an intensity of light reflected by said optical recording medium, depending on a wavelength of said reflected light,
wherein said efficiency adjustment member includes a first partial-efficiency adjustment member that changes said backward-path efficiency with respect to said first-wavelength light relatively to said backward-path efficiency with respect to said second- and third-wavelength lights, and a second partial-efficiency adjustment member that changes said backward-path efficiency with respect to said second-wavelength light relatively to said backward-path efficiency with respect to said first- and third-wavelength lights.

2. The optical head unit according to claim 1, wherein said efficiency adjustment member causes said backward-path efficiency with respect to a second-shortest-wavelength light among said first- through third-wavelength lights to be lower than said backward-path efficiency with respect to a shortest-wavelength light among said first- through third-wavelength lights, and causes said backward-path efficiency with respect to a longest-wavelength light among said first- through third-wavelength lights to be lower than said backward-path efficiency with respect to said second-shortest-wavelength light.

3. The optical head unit according to claim 1, wherein said first and second partial-efficiency adjustment members each include an optical thin film having a transmittance or reflectance that depends on a wavelength of incident light.

4. The optical head unit according to claim 3, wherein said optical thin film of said first partial-efficiency adjustment member transmits or reflects light at a specific transmittance or reflectance with respect to said first-wavelength light, and transmits or reflects incident light as it is with respect to said second- and third-wavelength lights.

5. The optical head unit according to claim 3, wherein said optical thin film of said second partial-efficiency adjustment member transmits or reflects light at a specific transmittance or reflectance with respect to said second-wavelength light, and transmits or reflects incident light as it is with respect to said first- and third-wavelength lights.

6. The optical head unit according to claim 3, wherein said first and second partial-efficiency adjustment members each include an optical thin film having a transmittance or reflectance that depends on a polarization direction and a wavelength of incident light, and also act an optical isolation member that isolates a forward-path light that advances from said light source toward said objective lens and a backward-path light that is reflected by said optical recording medium to advance toward said photodetector, from each other.

7. The optical head unit according to claim 1, wherein said first and second partial-efficiency adjustment members each include a diffraction grating having a transmittance that depends on a polarization direction of incident light.

8. The optical head unit according to claim 7, wherein said first partial-efficiency adjustment member comprises:
a wavelength plate that, upon receiving an incident linearly-polarized backward-path light having a specific polarization direction, passes therethrough said incident linearly-polarized light after rotating said specific polarization direction by 90 degrees with respect to said first-wavelength light, and passes therethrough said incident linearly-polarized light while maintaining said specific polarization direction with respect to said second- and third-wavelength lights; and
a diffraction grating that, upon receiving an incident backward-path light via said wavelength plate, passes therethrough said incident light as it is with respect to a linearly-polarized light having said specific polarization direction, and passes therethrough said incident light at a specific transmittance with respect to a linearly-polarized light having a polarization direction 90 degrees away from said specific polarization direction.

9. The optical head unit according to claim 7, wherein said second partial-efficiency adjustment member comprises:
a wavelength plate that, upon receiving an incident linearly-polarized backward-path light having a specific polarization direction, passes therethrough said incident linearly-polarized light after rotating said specific polarization direction by 90 degrees with respect to said second-wavelength light, and passes therethrough said incident linearly-polarized light while maintaining said specific polarization direction with respect to said first- and third-wavelength lights; and
a diffraction grating that, upon receiving an incident backward-path light via said wavelength plate, passes therethrough said incident light as it is with respect to a linearly-polarized light having said specific polarization direction, and passes therethrough said incident light at a specific transmittance with respect to a linearly-polarized light having a polarization direction 90 degrees away from said specific polarization direction.

10. An optical information recording/reproducing apparatus comprising:
the optical head unit according to claim 1:
a first circuitry that selectively drives said first through third light sources to emit one of said first- through third-wavelength lights;
a second circuitry that detects mark/space signals formed along an information track, provided on said optical recording medium, based on an output from said photodetector; and
a third circuitry that detects a focus error signal representing a positional deviation of said focused spot along an optical axis direction and a tracking error signal representing a positional deviation of said focused spot with respect to said information track within a plane perpendicular to said optical axis direction, and drives said objective lens based on said focus error signal and said tracking error signal.
